(19) United States
(12) Patent Application Publication
(10) Pub. No.: US 2023/0052255 A1
(43) Pub. Date: Feb. 16, 2023

(54) SYSTEM AND METHOD FOR OPTIMIZING A MACHINE LEARNING MODEL

(71) Applicant: Visa International Service Association, San Francisco, CA (US)

(72) Inventors: Runxin He, Austin, TX (US); Yu Gu, Austin, TX (US); Subir Roy, Austin, TX (US)

(73) Assignee: Visa International Service Association, San Francisco, CA (US)

(21) Appl. No.: 17/401,002

(22) Filed: Aug. 12, 2021

(51) Int. Cl. G06N 5/04

(52) U.S. Cl. CPC G06N 5/04

(57) ABSTRACT

A machine learning system includes a training platform and an inference platform, where the inference platform is coupled to receive the output of the training platform. Based upon an updating of hyperparameters in the training platform, an optimized inference model is configured to be deployed to the inference platform from the training platform. The optimized inference model is further optimized in the inference platform by using an observation difference between a client observation and a prediction response to update the optimized inference model. The updated optimized inference model is used to provide a prediction response to a client.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In artificially intelligent platforms, machine learning systems often utilize time-series forecasting that use a prediction model to predict future values based on previously observed values. Time-series data is a series of data points indexed (or listed or graphed) in time order. Time-series data has a natural temporal ordering that, in order to keep accurate, the prediction model used for training the time-series data must be trained regularly and frequently using the latest regional data. Many key financial technology applications, such as fraud detection and cross board transaction for currency exchange, utilize time-series models due to their superior performance. Therefore, a need exists to provide machine learning models that reduce the number of resources required to implement time-series applications.

### BRIEF DESCRIPTION OF THE DRAWINGS

FIG. 1 is a block diagram illustrating a system in accordance with some embodiments.

FIG. 2 illustrates a machine learning process used in the FIG. 1 in accordance with some embodiments.

FIG. 3 is a block diagram illustrating a training platform for performing a training-platform auto-tuning process of FIG. 1 in accordance with some embodiments.

FIG. 4 is a block diagram illustrating an inference platform for performing an inference-platform incremental updating process of FIG. 1 in accordance with some embodiments.

FIG. 5 illustrates a method for performing the training-platform auto-tuning process utilized in FIG. 1 in accordance with some embodiments.

FIG. 6 illustrates a method for performing the inference-platform incremental updating process utilized in FIG. 1 in accordance with some embodiments.

### DETAILED DESCRIPTION

A “graphics processing unit” or “GPU” may refer to an electronic circuit designed for the creation of images intended for output to a display device. The display device may be a screen, and the GPU may accelerate the creation of images in a frame buffer by rapidly manipulating and altering memory. GPUs may have a parallel structure that make them more efficient than general-purpose CPUs for algorithms where the processing of large blocks of data is done in parallel. Examples of GPUs may include Radeon™ HD 6000 Series, Polaris™ 11, NVIDIA GeForce™ 900 Series, NVIDIA Pascal™, etc.

In some embodiments, the term “artificial intelligence model” or “AI model” may refer to a model that may be used to predict outcomes in order achieve a pre-defined goal. The AI model may be developed using a learning algorithm, in which data or training data is classified based on known or inferred patterns. An AI model may also be referred to as a “machine learning model” or “predictive model.”

A “data set” may refer to a collection of related sets of information composed of separate elements that can be manipulated as a unit by a computer. A data set may comprise known data, which may be seen as past data or “historical data.” Data that is yet to be collected, may be referred to as future data or “unknown data.” When future data is received at a later point it time and recorded, it can be referred to as “new known data” or “recently known” data, and can be combined with initial known data to form a larger history.

“Unsupervised learning” may refer to a type of learning algorithm used to classify information in a dataset by labeling inputs and/or groups of inputs. One method of unsupervised learning can be cluster analysis, which can be used to find hidden patterns or grouping in data. The clusters may be modeled using a measure of similarity, which can be defined using one or metrics, such as Euclidean distance.

In some embodiments, “machine learning” may refer to an artificial intelligence process in which software applications may be trained to make accurate predictions through learning using the processes described herein. In some embodiments, the predictions can be generated by applying input data to models described herein.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet, and/or the like) that includes data. It will be appreciated that numerous other arrangements are possible.

As used herein, the term “computing device” or “communication device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer. As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

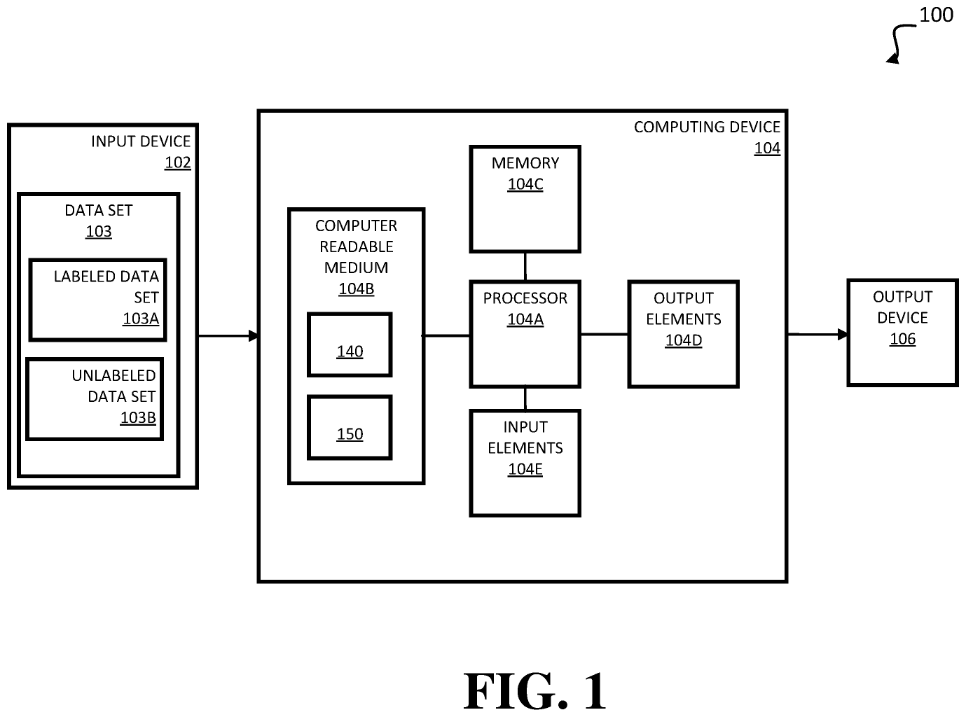

FIG. 1 illustrates a system 100 that supports a machine learning process in accordance with some embodiments. In some embodiments, the machine learning process utilizes a training-platform auto-tuning process and inference-platform incremental updating process to generate optimized inference models and prediction responses. In some embodiments, the system 100 may be, a system that, during the machine learning process, utilizes an algorithmic framework described herein that may be implemented on physical devices such as those depicted in FIG. 1.

In some embodiments, system 100 may include an input device 102, a computing device 104, and an output device 106. In some embodiments, the input device 102 may be any device such as a computer that is capable of storing and transmitting data. The input device 102 may comprise a data processor and a database capable of storing data set 103. In some embodiments, data set 103 may include a labeled data set 103A and an unlabeled data set 103B. The input device 102 may comprise a conventional, fault tolerant, relational, scalable, secure database such as those commercially available from Oracle™ or Sybase™. The input device 102 may be capable of transmitting the data set 103, including, for example, labeled data set 103A and/or the unlabeled data set 103B, to the computing device 104. In some embodiments, the computing device 104 may be capable of obtaining the data set 103, including the labeled data set 103A and/or the unlabeled data set 103B, from the input device 102.

In some embodiments, data transferred from the input device 102 to the computing device 104 may be in the form of signals which may be electrical, electromagnetic, optical, or any other signal capable of being received by the computing device 104 (collectively referred to as “electronic signals” or “electronic messages”). These electronic messages that may comprise data or instructions may be provided between the input device 102 and the computing device via a communications path or channel. In some embodiments, any suitable communication path or channel may be used such as, for instance, a wire or cable, fiber optics, a telephone line, a cellular link, a radio frequency (RF) link, a WAN or LAN network, the Internet, or any other suitable medium.

In some embodiments, the labeled data set 103A may contain any number of data points corresponding to training data that has been assigned to a class. In some embodiments, the data points in the labeled data set 103A may have any number of features. In some embodiments, the labeled data set 103A may include data with classes and features relating to insurance settlements or fraud. For example, some data in the labeled data set 103A may be assigned to a first class, “fraud,” and others to a second class, “no fraud.” The features may relate to the class and, in the fraud example, may correspond to fraud indicators such as “first time shopper,” “larger than normal transaction,” “transactions that include several of the same item,” “transaction amount,” “rush or overnight shipping,” etc.

In some embodiments, the unlabeled data set 103B may contain any number of data points corresponding to training data that has not yet been assigned a class. The data in the unlabeled data set 103B may have any number of features. In some embodiments, a data point in the unlabeled data set 103B may be, for example, {first time shopper: “yes”; larger than normal transaction: “no”; transactions that include several of the same item: “yes”, 5; transaction amount: $532.21; rush or overnight shipping: “yes”}, etc. A data point in the unlabeled data set 103B may be in any suitable format.

The computing device 104 may be any device capable of determining an output from an input. In some embodiments, the computing device 104 may include a processor 104A, a computer readable medium 104B, a memory 104C, one or more output elements 104D, and one or more input elements 104E.

In some embodiments, the computer readable medium 104B may comprise code, executable by the processor 104A, to implement a machine learning method including: (a) deploying, from a training platform, a first inference model to an inference platform, the first inference model having been updated in the training platform using a metric score to update a set of hyperparameters; and (b) generating, at an inference platform, a second inference model based upon an update of the first inference model, the update being based on an observation difference. In some embodiments, computer readable medium 104B may include a training platform 140 and an inference platform 150 to implement the machine learning method.

In some embodiments, the memory 104C may store code, the data set 103, the labeled data set 103A, the unlabeled data set 103B, a model (such as, e.g., an inference model), and any other relevant data or functional code. The memory 104C may be in the form of a secure element, a hardware security module; or any other suitable form of secure data storage. In some embodiments, the memory 104C may be a memory device.

The one or more output elements 104D may comprise any suitable device(s) that may output data. Examples of output elements 104D may include display screens, speakers, and data transmission devices.

The one or more input elements 104E may include any suitable device(s) capable of inputting data into the computing device 104. Examples of input elements include buttons, touchscreens, touch pads, microphones, data receiver devices, etc.

The computing device 104 may be capable of receiving data from the input device 102. The received data may be the labeled data set 103A, the unlabeled data set 1028, or both data sets. In some embodiments, the computing device 104 may be capable of determining an inference model based on the received data, and capable of transmitting the inference model to the output device 106. In some embodiments, the inference model may be a support vector machines.

The output device 106 may be any device capable of receiving an output. In some embodiments, the output device 106 may receive outputs from the computing device 104, such as an inference model. The output device 106 may be capable of using and/or performing operations on the inference model. For example, the computing device 104 may transmit an inference model to the output device 106. The output device 106 may then apply the inference model to other data sets.

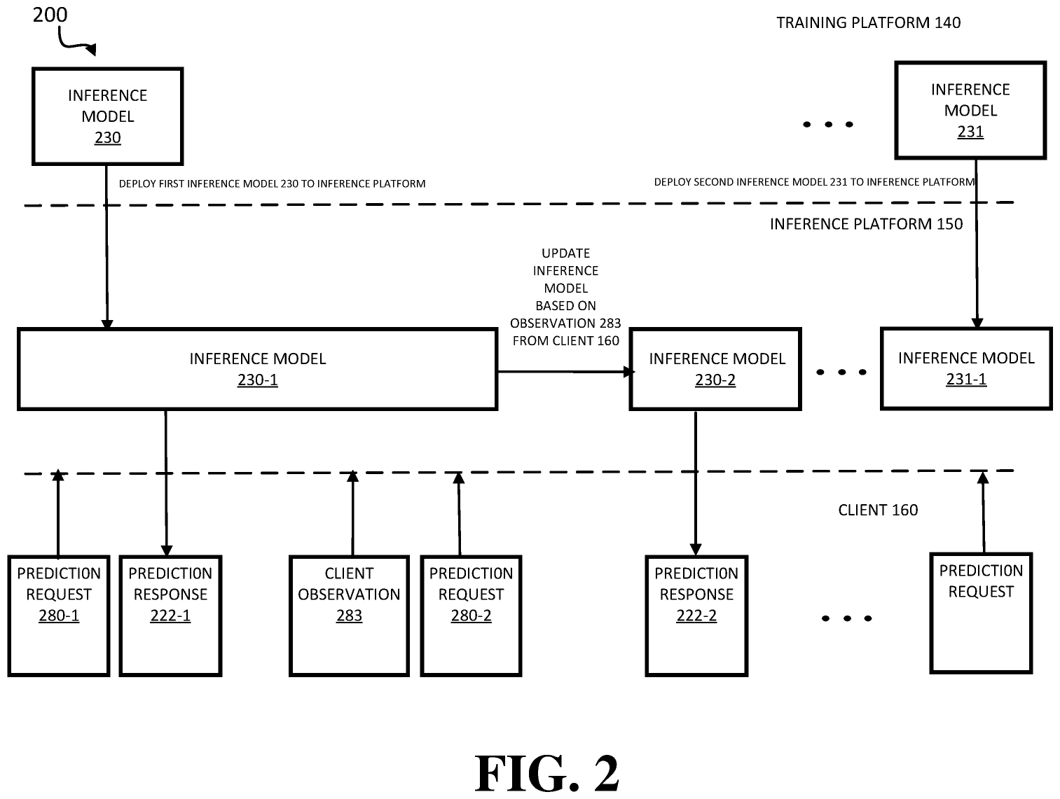

FIG. 2 illustrates a diagram depicting a machine learning process 200 of FIG. 1 in accordance with some embodiments. In some embodiments, the machine learning process 200 includes a training-platform auto-tuning process that is implemented by the training platform 140 to automatically tune and optimize the inference models provided to the inference platform 150. In addition, the machine learning process 200 includes an inference-platform incremental updating process that is implemented by inference platform 150 to incrementally update the inference models received from the training platform 140 to provide optimized prediction responses 222 to client 160.

In some embodiments, the machine learning process utilizes training platform 140 and inference platform 150 to perform the auto-tuning and incremental updating processes to generate prediction responses (e.g., prediction response 222-1 and prediction response 222-2) for client 160. In some embodiments, the training platform 140 includes training units (not shown) that are configured to train and deploy an inference model 230 and an inference model 231 to inference platform 150. In some embodiments, inference model 230 and inference model 231 may be, for example, deep learning models (e.g., support vector machines, recurrent neural networks, etc.) that utilize hyperparameters (discussed further below) that can be optimized using training-platform auto-tuning process to generate prediction responses 222. In some embodiments, hyperparameters are parameters used in a machine learning models that correspond to, for example, model size, network size, regularization weight, full connection layer variables, batching, shuffle type, and momentum, etc. In some embodiments, the values of the hyperparameters affect the training and performance of a machine learning model.

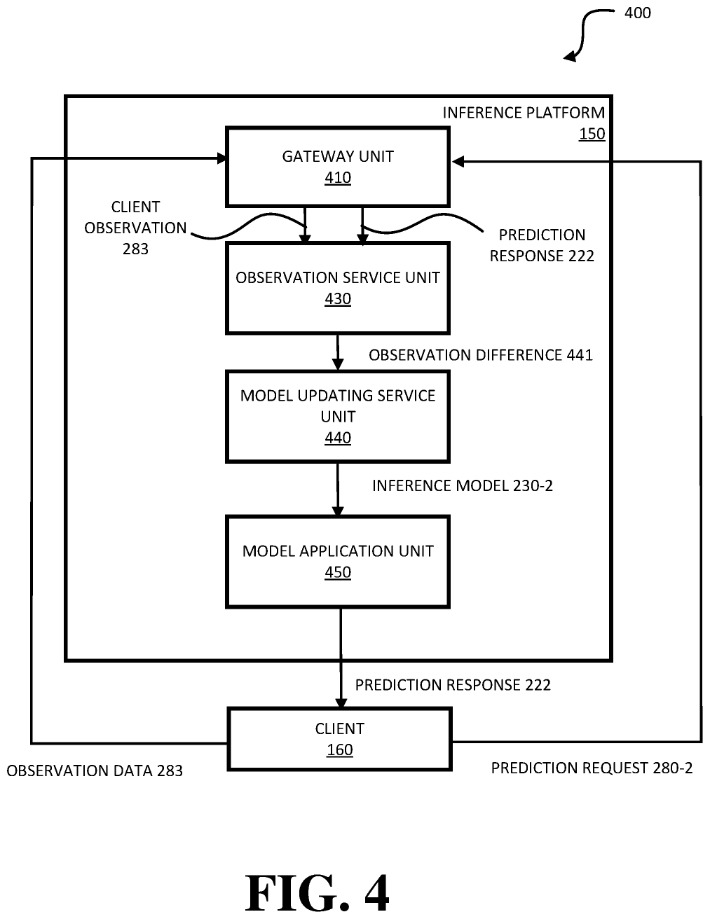

In some embodiments, inference platform 150 includes a model application unit (depicted in FIG. 4) that is configured to implement inference model 230 and inference model 231 that have been received from training platform 140. In some embodiments, inference platform 150 is configured to utilize updated versions of inference model 230 and inference model 231 to generate prediction responses 222 for client 160. In some embodiments, the prediction responses 222 are generated by inference platform 150 using the inference-platform incremental updating process by incrementally updating the inference models that are deployed by the training platform 140 and generated using the training-platform auto-tuning process.

In some embodiments, client 160 represents a client that provides prediction requests 280 to inference platform 150. In addition, client 160 provides a client observation 283 in response to the prediction responses 222 provided by the inference platform 150. In some embodiments, the client observation 283 includes observation data that the client 160 provides in observation of the prediction responses 222 generated by the inference platform 150.

In some embodiments, in operation, training platform 140 receives input data (not shown) that is used to train the inference model 230. In some embodiments, inference model 230-1 is the initial inference model that is trained and deployed by training platform 140 to inference platform 150 that uses an initial set of hyperparameters for training using the training data. In some embodiments, the training data may be collected as existing records. Existing records can be any data from which patterns can be determined from. Existing records may be, for example, user data collected over a network, such as user browser history or user spending history.

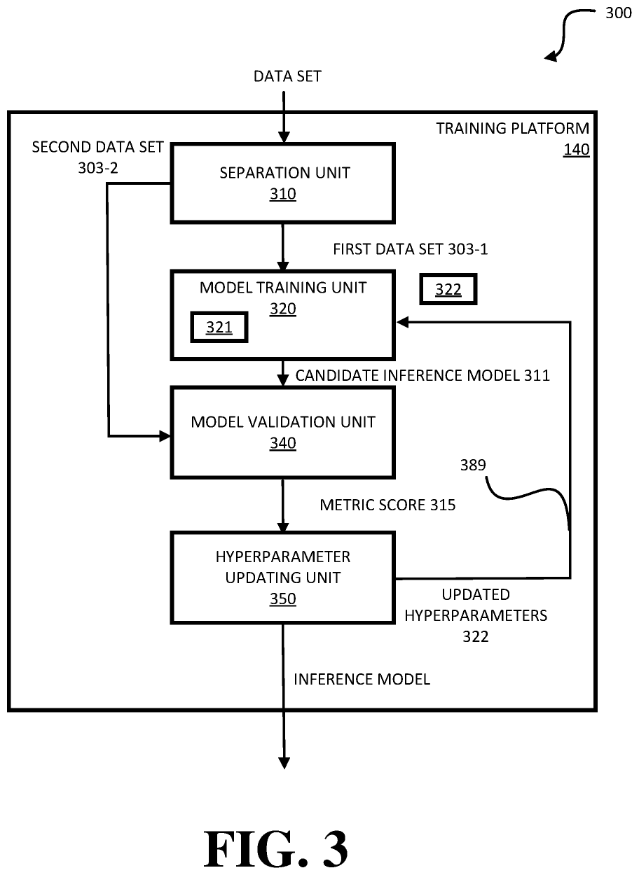

In some embodiments, training platform 140 receives the training data and commences the process of using the training-platform auto-tuning process to generate the inference models provided to inference platform 150. In some embodiments, the training-platform auto-tuning process is an offline iterative process that includes, for example, generating a metric score based upon a validation of candidate inference models, and utilizing the metric score generated during the validation of the candidate inference models to generate optimized hyperparameters (described further in detail below with reference to FIG. 3). In some embodiments, the optimized hyperparameters are utilized by training platform 140 to generate subsequent inference models, such as, for example, inference model 231. In some embodiments, training platform 140 generates the inference model 230-1 using the training-platform auto-tuning process and provides the inference model 230-1 to inference platform 150.

In some embodiments, inference platform 150 onboards inference model 230-1 from training platform 140 and uses the inference model 230-1 to generate prediction response 222-1. In some embodiments, to initiate the process of generating prediction response 222-1, inference platform 150 receives a first prediction request 280-1 from client 160. In some embodiments, the “prediction request” received from client 160 may be a request for a predicted answer to a question. For example, a prediction request may be a request for some information about a future event, a classification prediction, an optimization, etc. The prediction request may be in the form of natural language (e.g., as an English sentence) or may be in a computer-readable format (e.g., as a vector). In some embodiments, prediction responses 220 can be, for example, a prediction for a settlement for insurance purposes, a classification of an image (e.g., identifying images of cats on the Internet) or as another example, a recommendation (e.g., a movie that a user may like or a restaurant that a consumer might enjoy). In some embodiments, after generating the first prediction response 222-1 using inference model 230-1, inference platform 150 provides the first prediction response 222-1 to client 160.

In some embodiments, client 160 receives the prediction response 222-1 from inference platform 150 and uses the prediction response 222-1 to generate a client observation 283. The client observation 283 is an observation made of the prediction response 222 by client 160 associated with the previous prediction request 280-1. In some embodiments, client observation 283 includes observation data based on the received prediction response 222-1. In some embodiments, after generating the client observation 283, client 160 provides the client observation 283 and a new prediction request 280-2 to inference platform 150.

In some embodiments, inference platform 150 receives client observation 283 from client 160 and prediction request 280-2 from client 160 and commences the process of performing the inference-platform incremental updating process. In some embodiments, the inference-platform incremental updating process includes, for example, comparing the client observation 283 to the prediction response 222, and using the result of the comparison to update the inference model. In some embodiments, the comparison of the client observation 283 and the prediction response 222 includes measuring the error between the previous prediction (e.g., prediction response 222-1) and the client observation 283. In some embodiments, the result of the comparison is an observation difference which is generated by calculating the difference between the client observation 283 and the prediction response 222-1. In some embodiments, the observation difference is used by inference platform 150 to generate inference model 230-2 by updating the states and variables of the inference model 230-1. Inference platform 150 uses inference model 230-2 to generate prediction response 222-2 in response to the prediction request 280-2 received with client observation 283. In some embodiments, after generating the prediction response 222-2 using the inference model 230-2, inference platform 150 provides prediction response 222-2 to client 160.

In some embodiments, after providing prediction response 222-2 to client 160, training platform 140 deploys inference model 231-1 to replace inference model 230-2 in inference platform 150. In some embodiments, training platform 140 deploys inference model 231-1 to replace inference model 230-2 in inference platform 150 in regular intervals. The regular intervals may be, for example, a pre-determined amount of time, such as, three weeks, three months, every six months, etc. In some embodiments, inference platform 150 regularly updates inference model with new client observations 283 provided from client 160. In some embodiments, the inference model 231-1 deployed by training platform 140 is the inference model that has been optimized during the auto-tuning process of training platform 140 using the optimized hyperparameters. In some embodiments, inference platform 150 on-boards the inference model 230, inference model 231, etc. (e.g., “the well-trained models”) from training platform 140.

FIG. 3 illustrates an exemplary embodiment 300 of the training platform 140 of FIG. 1 in accordance with some embodiments. In some embodiments, the training platform 140 is configured to utilize the training-platform auto-tuning process described herein to generate inference model 230 and inference model 231. In some embodiments, an additional number of inference models may be generated by training platform 140 depending on, for example, the machine learning application used to generate prediction responses.

In some embodiments, training platform 140 includes a separation unit 310, a model training unit 320, a model validation unit 340, and a hyperparameter updating unit 350. In some embodiments, the separation unit 310 is coupled to the model training unit 320 and the model validation unit 340. In some embodiments, the model training unit 320 is coupled to the separation unit 310 and the model validation unit 340. The model validation unit 340 is coupled to the model training unit 320, the separation unit 310, and the hyperparameter updating unit 350. The hyperparameter updating unit 350 is coupled to the model training unit 320 and the inference platform 150 (depicted in FIG. 2 and FIG. 4).

In some embodiments, the separation unit 310 is configured to separate the training data, which may be, for example, a “whole data set”, into a first data set 303-1 and a second data set 303-2. In some embodiments, the first data set 303-1 is configured to be used for inference model training purposes and the second data set 303-2 is configured to be used for inference model validation and tuning purposes. In some embodiments, the model training unit 320 is configured to generate a candidate inference model 311 that is validated by model validation unit 340. In some embodiments, the model validation unit 340 is configured to validate the candidate inference model 311 output by the model training unit 320. In some embodiments, the hyperparameter updating unit 350 is configured to update hyperparameters 321 that are provided to model training unit 320 and used to generate the inference models (e.g., inference model 230 and inference model 231) that are provided to inference platform 150.

In some embodiments, during the training-platform auto-tuning process, separation unit 310 receives the data set 103 as input to the training platform 140 to train and validate inference model 230. In some embodiments, separation unit 310 separates the training data set into the first data set 303-1 and the second data set 303-2. In some embodiments, as stated previously, the first data set 303-1 is used to train the inference model 230 in the training platform 140 and the second data set 303-2 is used to validate and tune inference model 230 in the training platform 140. In some embodiments, after separation unit 310 separates the data set 103 into the first data set 303-1 and the second data set 303-2, separation unit 310 provides the second data set 303-2 to model validation unit 340 and the first data set 303-1 to model training unit 320.

In some embodiments, model training unit 320 receives the first data set 303-1 and commences the process of using a first set of hyperparameters 321 in a first iteration of the training-platform auto-tuning process to generate a candidate inference model 311. In some embodiments, in subsequent iterations of the training-platform auto-tuning process, model training unit 320 uses new updated hyperparameters 322 provided as feedback 389 from hyperparameter updating unit 350 to generate candidate inference model 311. In some embodiments, the first set of hyperparameters 321 are initial values of hyperparameters selected during initialization of model training unit 320. In some embodiments, model training unit 320 uses the first set of hyperparameters 321 to generate the candidate inference model 311. In some embodiments, model training unit 320 selects the candidate inference model 311 from a plurality of candidate inference models 311 to provide to model validation unit 340. Model training unit provides candidate inference model 311 to model validation unit 340.

In some embodiments, model validation unit 340 receives the candidate inference model 311 and a second data set 303-2 from the separation unit 310 and conducts a validation of the candidate inference model 311. In some embodiments, model validation unit 340 validates the candidate inference model 311 by using the second data set 303-2 and the candidate inference model 311 to generate a metric score 315, which may be denoted as prediction error L. In some embodiments, the metric score 315 is a score generated by model validation unit 340 that represents the prediction error of the candidate inference model 311 and is used to measure the accuracy of the candidate inference model 311. In some embodiments, the metric score 315 is also used to update the hyperparameters that are associated with the inference models that are deployed to inference platform 150.

In some embodiments, the metric score 315 is generated by model validation unit 340 using the cross-validation of the candidate inference models 311. Cross-validation may be described as a technique for evaluating inference models by training multiple inference models at, for example, model training unit 320, on subsets of the input data set and evaluating the inference models at, for example, model validation unit 340, using a complementary subset of data from the data set to generate a cross-validation prediction error. In some embodiments, metric score 315 may be considered the cross-validation prediction error, which is the prediction error generated at model validation unit 340 using the cross-validation technique. In some embodiments, after generating the metric score 315, model validation unit provides the metric score 315 to hyperparameter updating unit 350.

In some embodiments, hyperparameter updating unit 350 receives the metric score 315 and uses the metric score 315 to update a gradient of metric score 315 that is associated with each hyperparameter of the candidate inference model 311. In some embodiments, taking the gradient of the metric score 315 with respect to each hyperparameter of the inference candidate allows the gradient of the metric score 315 for each hyperparameter to be used to generate the updated hyperparameters 322 (depicted further in detail below), where each updated hyperparameter may be considered a function of the gradient of metric score 315 that is associated with each hyperparameter. For example, for hyperparameters associated with a candidate linear inference model 311, e.g.,

$$A , {W}^{- \frac{1}{2}} , C , and {V}^{- \frac{1}{2}} ,$$

which may represent, for example, the number of passes, regularization, model size, and shuffle type, etc., of the inference model, the gradient of metric score 315 with respect to each hyperparameter may be updated using, for example, the gradients

$${∇}_{A} L , {∇}_{{W}^{- \frac{1}{2}}} L , {∇}_{C} L , and {∇}_{{V}^{- \frac{1}{2}}} L ,$$

respectively. In some embodiments, the combination of the metric score 315 and the gradient of the metric score 315 associated with each hyperparameter may be considered cross-validation prediction values that are generated by model validation unit 340 and hyperparameter updating unit 350 based on the updated hyperparameters provided via feedback 389. In some embodiments, after the gradient associated with each hyperparameter has been calculated by hyperparameter updating unit 350 based on the metric score 315, hyperparameter updating unit 350 proceeds with updating the hyperparameters 321.

In some embodiments, hyperparameter updating unit 350 updates the hyperparameters 321 using the gradient of metric score 315 associated each hyperparameter 321 and the following hyperparameter updating technique:

$$A ← A + α {∇}_{A} L \\ {W}^{- \frac{1}{2}} ← {W}^{- \frac{1}{2}} + α {∇}_{{W}^{- \frac{1}{2}}} L \\ C ← C + α {∇}_{C} L \\ {V}^{- \frac{1}{2}} ← {V}^{- \frac{1}{2}} + α {∇}_{{V}^{- \frac{1}{2}}} L$$

where α is the learning rate, L is the metric score 315, and

$$A , {W}^{- \frac{1}{2}} , C , and {V}^{- \frac{1}{2}}$$

are the hyperparameters that get updated during the training-platform auto-tuning process. In some embodiments, the hyperparameters, e.g., hyperparameters 321 are updated during a first iteration the training-platform auto-tuning process and updated hyperparameters 322 are updated in subsequent iterations of the training-platform auto-tuning process.

In some embodiments, after the hyperparameters have been updated by hyperparameter updating unit 350, hyperparameter updating unit 350 proceeds with determining whether an optimal solution has been attained by the hyperparameter updating unit 350 or whether to continue with the iteration process. In some embodiments, when the iteration does not converge to the optimal solution, the optimal solution has not been achieved using the training-platform auto-tuning process, and the training platform 140 iterates back to model training unit 320 via feedback 389 to attain a new candidate inference model 311 that is used to determine a new metric score 315. In some embodiments, when the iteration does converge to the optimal solution using the training-platform auto-tuning process, hyperparameter updating unit 350 provides the inference model with the latest updated hyperparameters 322 to inference platform 150. In some embodiments, the inference model provided to inference platform 150 is an optimal, well-trained inference model that has been generated by training platform 140.

FIG. 4 illustrates an exemplary embodiment 400 of the inference platform 150 of FIG. 1 in accordance with some embodiments. In some embodiments, the inference platform 150 is configured to generate a prediction response using the inference-platform incremental updating process described herein. In some embodiments, the inference platform 150 includes a gateway unit 410, an observation service unit 430, a model updating service unit 440, and a model application unit 450. In some embodiments, gateway unit 410 is coupled to observation service unit 430 and client 160. In some embodiments, observation service unit 430 is coupled to gateway unit 410 and model updating service unit 440. In some embodiments, model updating service unit 440 is coupled to observation service unit 430 and model application unit 450. In some embodiments, model application unit 450 is coupled to model updating service unit 440 and client 160.

In some embodiments, gateway unit 410 is configured to perform data security operations for inference platform 150. In some embodiments, observation service unit 430 is configured to perform comparison operations that are used by model updating service unit 440 to generate an updated inference model in the inference platform 150. In some embodiments, model updating service unit 440 is configured to generate an updated inference model 230 using the result of the comparison operations performed by observation service unit 430. In some embodiments, model application unit 450 is configured generate prediction response 222 using the updated inference model 230.

In some embodiments, in operation, gateway unit 410 receives client observation 283 and prediction request 280-2 from client 160 and performs security operations on client observation 283 and prediction request 280-2. In some, the security operations performed by gateway unit 410 on client observation 382 and prediction request 280-2 includes, for example, data intrusion detection operations and data protection operations to protect client observation 283 and prediction responses 222. In some embodiments, after performing security operations for inference platform 150, gateway unit 410 provides client observation 283 and prediction response 222-1 to observation service unit 430.

In some embodiments, observation service unit 430 receives client observation 283 and prediction response 222-1 and compares client observation 283 to prediction response 222-1 to generate an observation difference 441. In some embodiments, the observation difference is a measure of the error between the previous prediction (e.g., prediction response 222-1) and client observation 283. In some embodiments, observation service unit 430 compares client observation 283 to prediction response 222-1 to generate the observation difference 441 by calculating the difference (e.g., error) between client observation 283 and prediction response 222-1. In some embodiments, the observation difference 441 generated by observation service unit 430 is provided to model updating service unit 440.

In some embodiments, model updating service unit 440 receives observation difference 441 and uses the observation difference 441 to update inference model 230-1 and generate inference model 230-2. In some embodiments, the model updating service unit 440 updates the inference model 230-1 by adjusting the states of the inference model 230-1 using the observation difference 441. In some embodiments, inference model 230-2, which has been updated based on client observation 283 from client 160, is provided to model application unit 450.

In some embodiments, the model application unit 450 receives inference model 230-2 from model updating service unit 440 and uses the updated inference model 230-2 to generate the prediction response 222-2 requested by client 160. The prediction response 222, which has been generated using the inference-platform incremental updating process, is provided to client 160 by inference platform 150.

In some embodiments, for each iteration of the inference-platform incremental updating process that generates an updated inference model, inference platform 150 updates the inference model, e.g., 230-2, etc., based on a new client observation 283 from client 160. In some embodiments, the inference-platform incremental updating process continues updating the inference model (e.g., inference model 230) until a new inference model (e.g., inference model 231) is deployed from the training platform 140.

In some embodiments, assuming for example, that inference model 230 is deployed from training platform 140 to a first data center and a second data center, at a later point in time, after the inference model 230 has been deployed by the training platform 140 to each data center, only the data gathered between a previous updating and the current updating is used to update the inference model 230. In some embodiments, the updating of the inference models can be implemented by incremental learning. In some embodiments, the workloads required to gather and update the inference models require less of a workload and are handled directly and automatically in each data center. In some embodiments, the workloads are handled directly and automatically in each data center by, for example, two service modules (e.g., a first service module and a second service module).

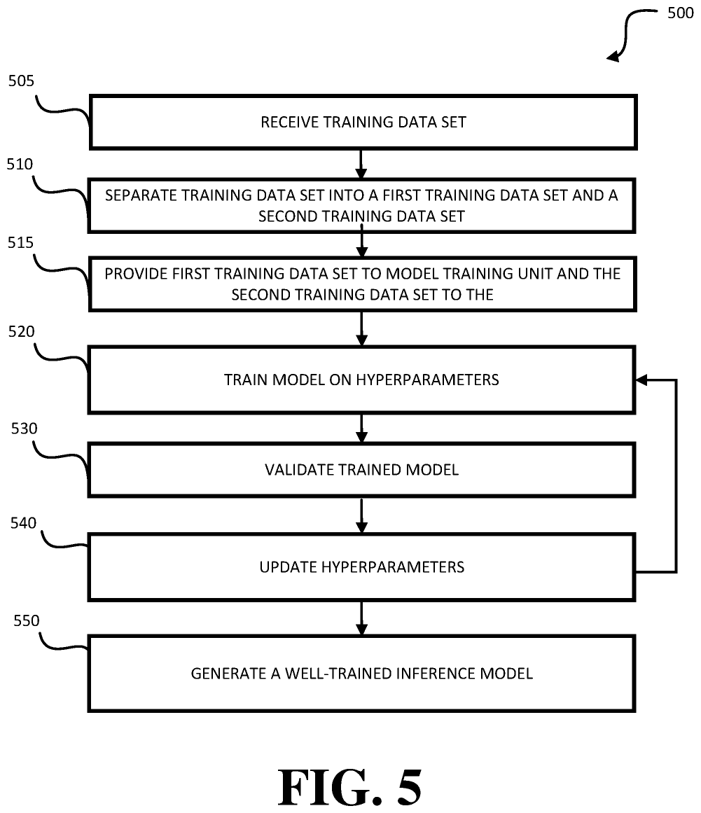

FIG. 5 illustrates a method 500 of performing the training-platform auto-tuning process of FIG. 1 in accordance with some embodiments. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments.

In some embodiments, with reference to FIGS. 1-4, at block 505, training platform 140 receives data set 103 from input device 102. In some embodiments, at block 510, the data set is separated into the first data set 303-1 and the second data set 303-2. In some embodiments, at block 515, the first data set 303-1 is provided to model training unit 320 to train the inference model in the training platform 140 and the second data set 303-2 is provided to model validation unit 340 for validation and tuning of the inference models.

In some embodiments, at block 520, model training unit 320 performs model training on the hyperparameters to generate candidate inference model 311. In some embodiments, during a first iteration of the method 500, a first initial set of hyperparameters are used to generate the candidate inference model 311. In some embodiments, during subsequent iterations of the method 500, an updated set of hyperparameters are used to generate the candidate inference model 311. In some embodiments, at block 530, model validation unit 340 validates the candidate inference model 311 using the second data set 303-2 received from separation unit 310 and the candidate inference model 311 received from the model training unit 320 and generates the metric score 315. In some embodiments, as stated previously, the metric score 315 generated by the model validation unit 340 is based on the accuracy of the candidate inference model 311.

In some embodiments, at block 540, hyperparameter updating unit 350 updates hyperparameters using the metric score 315 and generates updated hyperparameters 322. In some embodiments, the updated hyperparameters 322 are fed back to model training unit 320 by the hyperparameter updating unit 350 for use during a next iteration of the training-platform auto-tuning process to update the hyperparameters.

In some embodiments, at block 550, a well-trained inference model (e.g., inference model 230 or inference model 231) is generated by, for example, hyperparameter updating unit 350, using the updated hyperparameter 322 for deployment to inference platform 150.

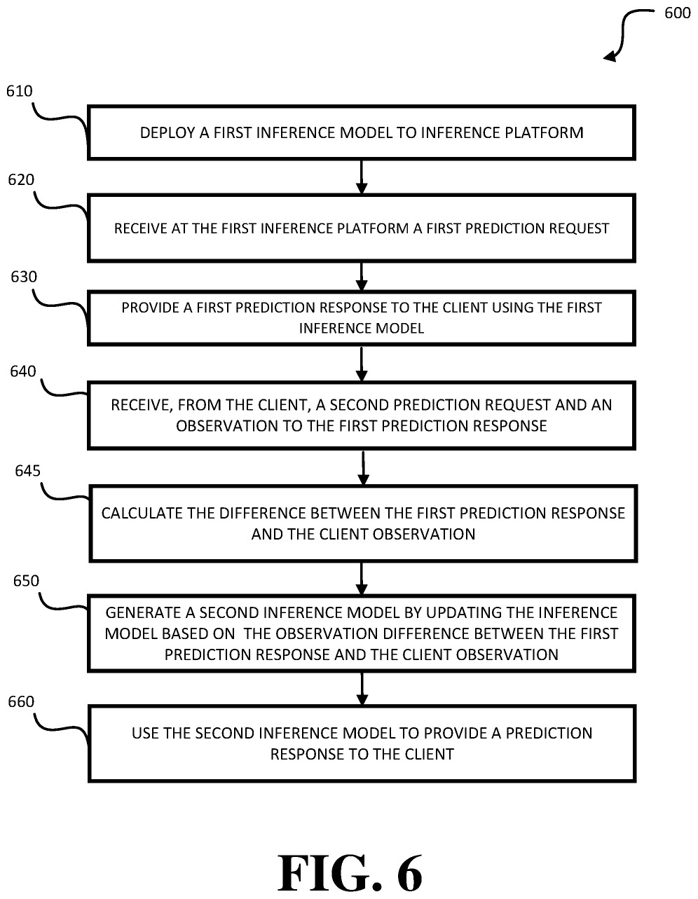

FIG. 6 illustrates a method 500 of performing the inference-platform incremental updating process of FIG. 1 in accordance with some embodiments. In some embodiments, with reference to FIGS. 1-5, at block 610, inference model 230-1 is deployed to inference platform 150 from training platform 140. In some embodiments, the inference platform 150 receives and onboards the inference model 230-1 in order to generate prediction responses for client 160. In some embodiments, at block 620, a first prediction request, e.g., prediction request 280-1, is received at the inference platform 150 from client 160. In some embodiments, at block 630, a first prediction response, e.g., prediction response 222-1, is generated using inference model 230-1 and provided to client 160 in response to the prediction request 280-1.

In some embodiments, at block 640, inference platform 150 receives the second prediction request 280-2 and client observation 283 of the prediction response 222-1 from client 160. In some embodiments, at block 645, observation service unit 430 generates the observation difference 441 by measuring the error between prediction response 222-1 and client observation 283.

In some embodiments, at block 650, a second inference model, e.g., inference model 230-2, is generated by model updating service unit 440 by updating the first inference model, e.g., inference model 230-1, using the observation difference 441 between the first prediction response 222-1 and the client observation 283 received from client 160. In some embodiments, at block 650, a second minor version inference model, e.g., inference model 230-2, is generated by model updating service unit 440 by updating the first inference model, e.g., inference model 230-1, using the observation difference 441 between the first prediction response 222-1 and the client observation 283 received from client 160.

In some embodiments, at block 660, the second inference model, e.g., inference model 230-2 is used to generate a second prediction response, e.g., prediction response 222-2, in response to the prediction request 280-2 received from client 160. In some embodiments, the prediction response 222-2 output by the inference model 230-2 has been generated using the inference-platform incremental updating process described herein.

In some embodiments, referring again to FIG. 3, in determining the inference model 230 and the inference model 231, hyperparameter updating unit 350 updates the hyperparameters by replacing the value of the metric score 315 in the gradient of each hyperparameter with a newly generated metric score 315 that has been generated by model validation unit 340. In some embodiments, after replacing the value of the metric score 315 in each gradient of each hyperparameter, hyperparameter updating unit 350 replaces the gradient of each hyperparameter to calculate the updated hyperparameters 322 that are provided to model training unit 320. In addition, in some embodiments, once convergence has occurred, hyperparameter updating unit 350 updates the inference model 230 with the newly updated hyperparameters 322 and provides the inference model 230 as a “well-trained model” to inference platform 150.

In some embodiments, a system includes a training platform and an inference platform coupled to the training platform, wherein based upon an updating of hyperparameters in the training platform, an optimized inference model is configured to be deployed to the inference platform. In some embodiments of the system, the training platform updates the hyperparameters using a metric score generated in the training platform. In some embodiments of the system, the metric score is indicative of an accuracy of a candidate inference model. In some embodiments of the system, the optimized inference model is generated in the training platform by using a feedback of the updated hyperparameters. In some embodiments of the system, the inference platform updates the optimized inference model to generate a second version of the optimized inference model. In some embodiments of the system, the inference platform updates the optimized inference model by using a client observation and a first prediction response. In some embodiments of the system, an observation difference is generated by the inference platform by calculating a difference between the client observation and the first prediction response. In some embodiments of the system, the second version of the optimized inference model is used to generate a second prediction response. In some embodiments of the system, the second prediction response is generated in response to a second prediction request.

In some embodiments, a training platform includes a model training unit, a model validation unit coupled to the model training unit, and a hyperparameter updating unit coupled to the model validation unit, wherein based upon an updating of hyperparameters associated with an inference model generated in the model training unit, an optimized inference model is output by the training platform. In some embodiments of the training platform, the hyperparameter updating unit uses a metric score to update the hyperparameters. In some embodiments of the training platform, the metric score used to update the hyperparameters is indicative of an accuracy of the inference model. In some embodiments of the training platform, the hyperparameters are updated using a gradient of the hyperparameters. In some embodiments, the training platform further includes a separation unit coupled to the model training unit, wherein the separation unit provides a first data set to the model training unit and a second data set to the model validation unit. In some embodiments of the training platform, the model validation unit uses a candidate inference model and the second data set to generate the metric score.

In some embodiments, a method includes generating, at an observation service unit, an observation difference, and updating, at the model updating service unit, a first prediction model based upon the observation difference. In some embodiments of the method, in order to generate the observation difference, the observation service unit measures an error between a client observation and a previous prediction response generated by the first prediction model. In some embodiments of the method, a client provides a first prediction request and the client observation to the observation service unit to generate the observation difference. In some embodiments, the method further includes generating a second prediction model based upon the updating of the first prediction model. In some embodiments, the method further includes using the second prediction model to generate a second prediction response.

For purposes of the description, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

What is claimed is:

1. A system, comprising:
a training platform; and
an inference platform coupled to the training platform, wherein based upon an updating of hyperparameters in the training platform, an optimized inference model is configured to be deployed to the inference platform.

2. The system of claim 1, wherein:
the training platform updates the hyperparameters using a metric score generated in the training platform.

3. The system of claim 2, wherein:
the metric score is indicative of an accuracy of a candidate inference model.

4. The system of claim 3, wherein:
the optimized inference model is generated in the training platform by using a feedback of the updated hyperparameters.

5. The system of claim 4, wherein:
the inference platform updates the optimized inference model to generate a second version of the optimized inference model.

6. The system of claim 5, wherein:
the inference platform updates the optimized inference model by using a client observation and a first prediction response.

7. The system of claim 6, wherein:
an observation difference is generated by the inference platform by calculating a difference between the client observation and the first prediction response.

8. The system of claim 7, wherein:
the second version of the optimized inference model is used to generate a second prediction response.

9. The system of claim 8, wherein:
the second prediction response is generated in response to a second prediction request.

10. A training platform, comprising:
a model training unit;
a model validation unit coupled to the model training unit; and
a hyperparameter updating unit coupled to the model validation unit, wherein based upon an updating of hyperparameters associated with an inference model generated in the model training unit, an optimized inference model is output by the training platform.

11. The training platform of claim 10, wherein:
the hyperparameter updating unit uses a metric score to update the hyperparameters.

12. The training platform of claim 11, wherein:
the metric score used to update the hyperparameters is indicative of an accuracy of the inference model.

13. The training platform of claim 12, wherein:
the hyperparameters are updated using a gradient of the hyperparameters.

14. The training platform of claim 13, further comprising:
a separation unit coupled to the model training unit, wherein the separation unit provides a first data set to the model training unit and a second data set to the model validation unit.

15. The training platform of claim 14, wherein:
the model validation unit uses a candidate inference model and the second data set to generate the metric score.

16. A method, comprising:
generating, at an observation service unit, an observation difference; and
updating, at the model updating service unit, a first prediction model based upon the observation difference.

17. The method of claim 16, wherein:
in order to generate the observation difference, the observation service unit measures an error between a client observation and a previous prediction response generated by the first prediction model.

18. The method of claim 17, wherein:
a client provides a first prediction request and the client observation to the observation service unit to generate the observation difference.

19. The method of claim 18, further comprising:
generating a second prediction model based upon the updating of the first prediction model.

20. The method of claim 19, further comprising:
using the second prediction model to generate a second prediction response.
